(19) United States
(12) Patent Application Publication
(10) Pub. No.: US 2004/0111235 A1
(43) Pub. Date: Jun. 10, 2004

(54) Ultrasonic gauge online calibration system

(76) Inventor: Donald H. Haskins, Lebanon, OH (US)

Correspondence Address: A PATENT LAWYER CORP, PC, R WILLIAM GRAHAM, 22 S ST CLAIR ST, DAYTON, OH, 45402, US

(21) Appl. No.: 10/314,847

(22) Filed: Dec. 9, 2002

(51) Int. Cl. G06F 15/00

(52) U.S. Cl. 702/171

(57) ABSTRACT

A method for measuring wall thickness of an annular material during a manufacturing process includes the steps of hot die forming an annular material, employing an ultrasonic gauge about the formed annular material while in a hot state and which is operably equipped to produce an output signal indicative of concentricity thereof, and employing a computer based device to calibrate the ultrasonic gauge using a calculated finished cold formed wall thickness for the annular material. The method further employs a laser gauge to provide an output to the computer indicative of the outer diameter size of the formed annular material when cooled, wherein the computer uses the output in determining the calibration. A system is also provided.

### TECHNICAL FIELD

This invention relates to a method and system for measuring wall thickness of an annular material during a manufacturing process. More particularly, it relates to method and system for measuring wall thickness in applying a coating to a coated material using a wall thickness gauge.

### BACKGROUND OF THE INVENTION

In any type of extrusion process, a core material is drawn or pulled through a die which coats the core material and is taken up on spools after being coated. A typical coating applicator includes a die through which core material passes and through which the coating material applies a coating onto the core material. The coating thickness around the core is dependent upon the amount of material applied at the point of application, material density, temperature, speed of the drawn core material and humidity of the forming environment.

It is important in the production of a coated core material that the coating process provides a coating having a uniform thickness. Maintaining a uniform thickness of the outer coating assures that the minimal amount of waste occurs in applying the coated material.

An important factor relating to achieving proper coating thickness is concentricity. An off-centered core material in the coating process may result in not adequately covering or protecting the core material surface which could have an adverse effect on insulation of the core material as well as its strength. The thickness of the coating is important not only from the standpoint that it is sufficient to adequately cover and protect the surface of the core material, but also that it is not so thick that it impairs subsequent manufacturing operations and/or cost.

Adjustments to compensate for variables, such as the level of the coating material or its properties, temperature, changes in line speed, viscosity of the coating material, humidity and wear or inaccuracies of die manufacture are typically accounted for by the operator. Should any of these change during the forming process, it can result in improper coating. For example, as the draw speed of the core material changes, the coating increases or decreases in proportion to speed.

Gauges exist to measure the concentricity of a coated product. Typically, an ultrasonic gauge is disposed adjacent a freshly coated product so that a wall thickness can be determined as well as concentricity. Typically, another gauge which is significantly spaced down line from the concentricity gauge measures the outer diameter of the finished product. If the coating is insufficient in some aspect, one of the variables, such as line speed is adjusted to compensate the required change.

The concentricity gauge, typically an ultrasonic gauge, provides wall thickness and concentricity readings which are dependent on material density, material applied, temperature and humidity. As one of these variables changes, the readings change. While the material applied can be relatively fixed during the coating process, the other factors are subject to change during a coating process and thus negatively affect the reading output of the concentricity gauge. As a result, the operator must calibrate the gauge readings to ensure that the measured wall thickness accurately represent the actual wall thickness and concentricity. To accomplish this, the operator must stop the production line, cut a sample from the drawn product and physically measure it with an instrument such as a micrometer. The operator then inputs the value into the computer to calibrate the readings as previously mentioned and restarts the production line. This procedure inherently induces error into the measured values used to calibrate the readings from the ultrasonic gauge because it relies on using accurate mechanical measurement devices to measure the damaged product. The calibration also relies on an accurate interpretation of the physically measured readings in conjunction with the operator properly entering the information into the calibrating computer. In addition to the potential for human error, this method of calibration requires lost production time and wasted product.

A need remains for an improved method and system for coating core material by which optimal coating thickness can be achieved as well as concentricity maintained. Further, there is need for an adaptive measurement system which operates within a range of the previously mentioned changing variables. The present invention addresses these needs.

### SUMMARY OF THE INVENTION

It is an object to improve the coating process for a core material.

It is another object to provide an improved system for measuring wall thickness.

It is still another object to improve ultrasonic gauge measurement.

It is yet another object to provide an improved method of forming a coated core material.

Still another object is to provide a method of measuring concentricity.

Accordingly, the present invention is directed to method and system for measuring wall thickness of an annular material during a manufacturing process. The method includes the steps of hot die forming an annular material, employing an ultrasonic gauge about the formed annular material while in a hot state and which is operably equipped to produce an output signal indicative of concentricity thereof, and employing a computer based device to calibrate the ultrasonic gauge using a calculated finished cold formed wall thickness for the annular material. The method further employs a laser gauge to provide an output to the computer indicative of the outer diameter size of the formed annular material when cooled, wherein the computer uses the output in determining the calibration.

The method is further characterized to form the annular material about a core material. The method employs another laser gauge to provide an output to the computer indicative of the outer diameter size of the core material, wherein the computer uses the output in determining the calibration.

A system is provided which includes the aforesaid components to carry out the method. The system includes a die for hot forming an annular material, an ultrasonic gauge disposed in a manner to receive thereby formed annular material while in a hot state, wherein the ultrasonic gauge is operably equipped to produce an output signal indicative of concentricity thereof and a computer based device operably connected to the ultrasonic gauge for calibrating the ultrasonic gauge using a calculated finished wall thickness. The system further includes a laser gauge operably connected to the computer-based device for providing an output to the computer indicative of actual outer diameter size of the formed annular material when cooled and another laser gauge operably connected to the computer-based device for providing an output to the computer indicative of actual inner diameter size of the annular material when cooled, wherein the computer uses the laser gauge outputs in determining the calibration.

Other objects and features of the present invention will be more readily understood from the following detailed description of specific embodiments thereof when read in conjunction with the accompanying drawings

### BRIEF DESCRIPTION OF THE DRAWINGS

FIG. 1 is a perspective view of the invention shown in use for coating a drawn core material;

FIG. 2 depicts a cross section of a product formed by the invention.

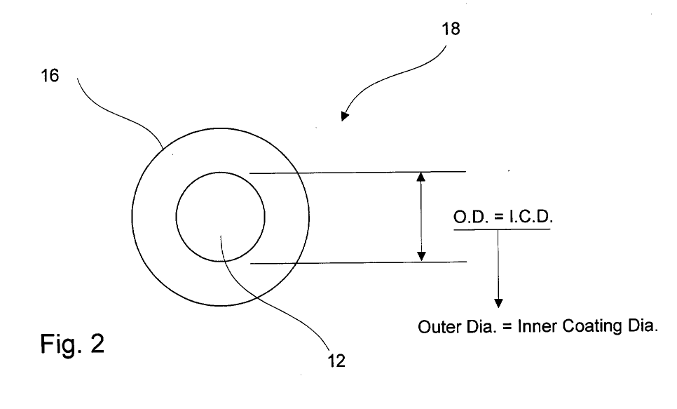

### DETAILED DESCRIPTION

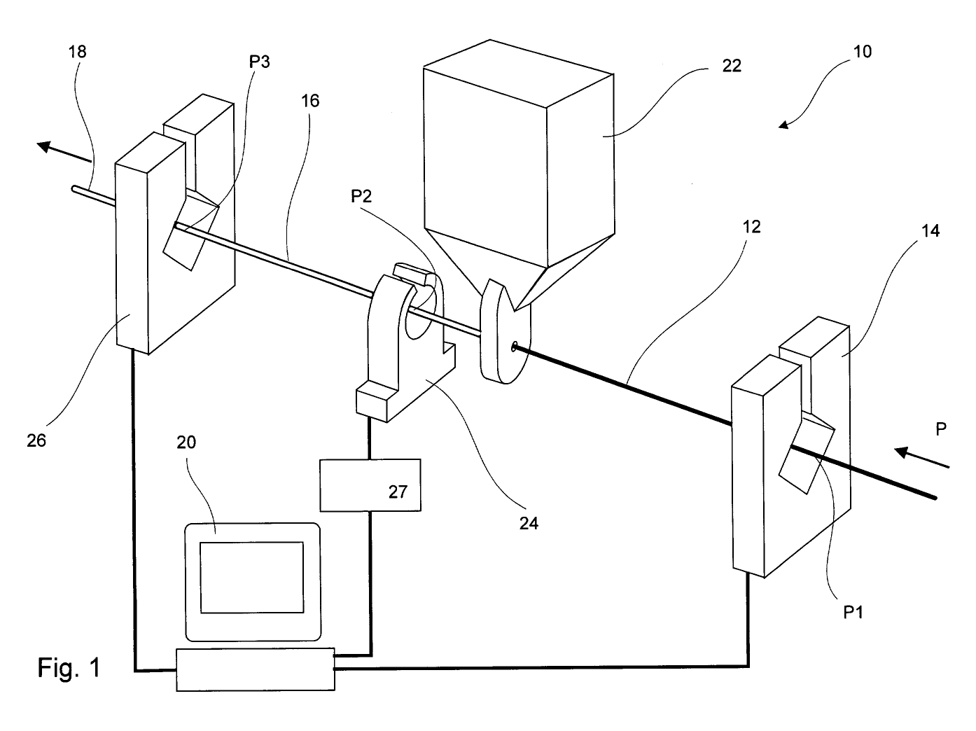

Referring now to FIG. 1, there is shown a system which is designated generally by the numeral 10 and in which is used to draw an inner core material 12. The core material 12 can be a wire, fiber or other material to be coated.

As can be seen in FIG. 1, the elements of the core material 12 is passed through a laser gauge 14 for measuring outer diameter size of the core material 12 at a predetermined point P1 along the path P in which the core material 12 moves. The outer diameter size (OD) is equivalent to the inner coating diameter size (ICD) of the formed annular coating 16.

The laser gauge 14 is operatively connected to a computer based device 20 in a manner to receive output signals therefrom indicative of the ICD of the coating 16, i.e., the OD signal of the core material 12. The core material 12 is passed through a hot material extrusion die 22 as is known in the art for applying the coating 16 over the core material 12.

An ultrasonic gauge 24 is operably disposed at a point P2 shortly after the coating 16 is formed and is positioned about the coating 16 to provide an output indicative of the wall thickness of the newly formed coating 16 about the core material 12. It is noted that P2 represents the point at time in which the coating 16 is in a “hot” state, i.e., a state wherein the coating 16 has not cooled to a finished or dimensionally unchanging state. The gauge 24 includes a plurality of transducers as is known in the art for generating signals relating to the wall thickness. A signal processor 27 is operatively connected to the computer based device 20 to receive the measurement output of the gauge 24 for purposes of enabling proper wall thickness concentricity to be maintained of the coating 16 onto the core material 12. Additionally, the computer 20 uses the output signals in calibrating signal processor 27 as will be further described hereinafter.

Axially spaced downline from the gauge 24 along path P at point P3 is another laser gauge 26 for measuring the finished outer diameter (FOD) of the finished cooled product 18. The laser gauge 26 provides an output signal which is indicative of the outer diameter size of the product 18. The computer based device 20 receives the output signal from the gauge 26 and uses this in calibrating signal processor 27.

Herein lies an important aspect of the present invention. The computer based device 20 includes operating software for performing, among other things, calibration of signal processor 27.

The purpose of automatically calibrating the signal processor 27 is to modify the hot temperature wall thickness readings obtained at the ultrasonic gauge 24 to make the readings (output signals) obtained at P2 reflect the finished wall thickness measured at P3 from the second outer diameter laser gauge 26 at a coincident point throughout the formation of product 18. This is done by first calculating the “actual cooled wall thickness” (CW) with the laser gauges 14 and 26. The computer based device 20 uses the first laser gauge 14 to monitor the ICD and a second laser gauge 26 to monitor the FOD at coincident points, i.e., P1 of core material and P3 of the product and are the same relative monitored point on the core material 12 at times t1 and t3, respectively. The software calculates CW using the formula CW=(FOD−ICD)/2.

With this value, CW=(VLG*TLG)/2, where “VLG” is speed of sound through the cooled outer wall and “TLG” is time for the ultrasonic ping from the gauge 24 to travel through the wall and reflect back out of the wall. The ultrasonic gauge 24 is triggered by the signal processor 27 to take a measurement at the transit time (TUS) of the ultrasonic sound through the coating 16 at a point P2 coincident to the two laser gauge 14 and 26 measurements at P1 and P3 as represented by ICD and FOD, respectively.

To determine the “calculated cooled wall thickness” (DC), this is performed from the measurement point P2 of the ultrasonic gauge 24, wherein the software calculates a compensated sound velocity (VCOMP ) through the coating 16 using the following equation:

DC=CW=(VLG*TLG)/2=n*(VUS*TUS)/2;

VCOMP=VUS*n;

where n represents the percent (%) change in sound velocity due to product cooling. (VUS) and (n) are both unknowns at this point to the system 10.

Substituting VCOMP back into the equation for CW provides,

DC=CW=(VLG*TLG)/2=(TUS*VCOMP)/2

Solving for VCOMP provides:

VCOMP=CW/TUS*2;

VCOMP represents the calibration factor which is subsequently used by signal processor 27 in conjunction with the signals produced by ultrasonic gauge 24 to calculate the cooled wall thickness measurements for TUS made at a hot location.

All subsequent DC measurements are then calculated as:

DC=(TUS*VCOMP)/2

Again, DC is the calculated wall thickness of the cooled, finished product 18 when measured as a hot wall thickness at the ultrasonic gauge 24. With this calibration aid, the system 10 can adjust the draw speed and or die parameters to maintain the proper coating thickness about the core material diameter.

By so providing, the present invention can better maintain the coating thickness over the core material in a coating process. The invention obviates the need for recalibration of the ultrasonic signal processor as a result of the automated system described herein. Inaccuracies in manual calibration of the ultrasonic signal processor are also eliminated by the present invention.

It is to be understood that the above-described arrangements are simply illustrative of the invention. Other arrangements may be devised by those skilled in the art which will embody the principles of the invention and fall within the spirit and scope thereof. The claims attached hereto should therefore be afforded the broader scope of modifications, derivations and improvements readily apparent to one skilled in the art.

What is claimed is:

1. A method for measuring wall thickness of an annular material during a manufacturing process, which includes the steps of:
hot die forming an annular material;
employing an ultrasonic gauge about said formed annular material while in a hot state, wherein said ultrasonic gauge is operably equipped to produce an output signal indicative of the wall thickness thereof; and
employing a computer based device having a signal processor to calibrate said ultrasonic gauge output signal using a calculated finished wall thickness.

2. The method of claim 1, which further includes employing a laser gauge to provide an output to the computer based device indicative of actual outer diameter size of said formed annular material when cooled, wherein said computer uses said output in determining said calibration.

3. The method of claim 1, which is further characterized to form said annular material about a core material.

4. The method of claim 3, which further includes employing a laser gauge to provide an output to said computer based device indicative of actual outer diameter size of said core material, wherein said computer uses said output in determining said calibration.

5. The method of claim 2, which further includes employing another laser gauge to provide an output to said computer indicative of actual inner diameter size of said annular material when cooled, wherein said computer uses said output of said another laser gauge in determining said calibration.

6. The method of claim 1, wherein said signal processor calibrates using the formula VCOMP=CW/TUS*2, wherein VCOMP represents compensated sound velocity through said annular material which is used with said ultrasonic gauge, where CW is an actual cooled wall thickness provided by said computer based device and TUS is transit time of sound through said annular material made at said hot state and further uses the formula DC=(TUS*VCOMP)/2, wherein DC is calculated wall thickness of said finished wall thickness when cooled when measured at said hot state.

7. A system for measuring wall thickness of an annular material during a manufacturing process, which includes:
a die for hot forming an annular material;
an ultrasonic gauge disposed in a manner to receive thereby formed annular material while in a hot state, wherein said ultrasonic gauge is operably equipped to produce an output signal indicative of wall thickness thereof; and
a signal processor operably connected to said ultrasonic gauge for converting said output signals to a calculated finished wall thickness and a computer based device operably connected to said signal processor for calibrating said signal processor using a calculated finished wall thickness.

8. The system of claim 7, which further includes a laser gauge operably connected to said computer-based device for providing an output to said computer indicative of actual outer diameter size of said formed annular material when cooled, wherein said computer based device uses said laser gauge output in determining said calibration.

9. The system of claim 7, wherein said die is further characterized to form said annular material about a core material.

10. The system of claim 9, which further includes a laser gauge operably connected to said computer-based device for providing an output to said computer based device indicative of actual outer diameter size of said core material, wherein said computer based device uses said laser gauge output in determining said calibration.

11. The system of claim 8, which further includes another laser gauge operably connected to said computer-based device for providing an output to said computer indicative of actual inner diameter size of said annular material when cooled, wherein said computer based device uses said another laser gauge output in determining said calibration

12. The system of claim 7, wherein said computer based device calibrates using the formula VCOMP=CW/TUS*2, wherein VCOMP represents compensated sound velocity through said annular material which is used with said ultrasonic gauge, where CW is actual cooled wall thickness provided by said computer based device and TUS is transit time of sound through said annular material made at said hot state and further uses the formula DC=(TUS*VCOMP)/2, wherein DC is calculated wall thickness of said finished wall thickness when cooled when measured as said hot state.
